(19) United States
(12) Patent Application Publication
(10) Pub. No.: US 2018/0322092 A1
(43) Pub. Date: Nov. 8, 2018

(54) DEVICE, METHOD AND SYSTEM FOR ROUTING GLOBAL ASSISTANT SIGNALS IN A NETWORK-ON-CHIP

(71) Applicants: HUAWEI INTERNATIONAL PTE. LTD., Singapore (SG); THE TRUSTEES OF PRINCETON UNIVERSITY, Princeton, NJ (US)

(72) Inventors: Zhiguo GE, Singapore (SG); Xianmin CHEN, Fremont, CA (US); Niraj K. JHA, Princeton, NJ (US); Naxin ZHANG, Singapore (SG)

(21) Appl. No.: 16/035,258

(22) Filed: Jul. 13, 2018

Related U.S. Application Data
(63) Continuation of application No. PCT/SG2017/050015, filed on Jan. 13, 2017.

(30) Foreign Application Priority Data
Jan. 14, 2016 (SG) 10201600276Y

(51) Int. Cl. G06F 15/78; H04L 12/775; H04L 12/801

(52) U.S. Cl. CPC G06F 15/7825; H04L 47/10; H04L 45/58

(57) ABSTRACT

Embodiments of the application provide device, method and system for routing global assistant signals in a NoC. The device comprises: a signal distributing element having an associated intermediate router provided in a system for routing global assistant signals in a NoC which includes at least one intermediate router electrically interposed between a source router and a destination router, wherein the signal distributing element is configured to: based on a predetermined criterion, select either local global assistant signals generated by the associated intermediate router or upstream global assistant signals received from an upstream router of the associated intermediate router as current global assistant signals to be sent to a downstream router of the associated intermediate router.

### CROSS-REFERENCE TO RELATED APPLICATIONS

This application is a continuation of International Application No. PCT/SG2017/050015, filed on Jan. 13, 2017, which claims priority to Singapore Patent Application No. SG10201600276Y, filed on Jan. 14, 2016, both of which are hereby incorporated by reference in their entireties.

### FIELD OF INVENTION

The application generally relates to Network-on-Chip (NoC), e.g., Single-cycle Multiple-hop Asynchronous Repeated Traversal (SMART) NoC and more particularly, device, method and system for routing global assistant signals, e.g., SMART-hop Setup Request (SSR) signals, in a NoC.

### BACKGROUND

Typically, a SMART NoC includes a plurality of SMART routers where a flit can traverse multi-hops within one routing cycle. To build an express SMART routing system across multi-hops, the plurality of routers in the routing system need to be synchronized. The synchronization is achieved through SSR signals which are one type of global assistant signals. Specifically, when a router intends to send a flit to a destination router, it will generate a group of SSR signals and broadcast the generated SSR signals to all of the downstream routers within the maximum hops per cycle (HPCmax). Each router in the routing system takes the broadcasted SSR signals as inputs, arbitrates the global SSRs and its local flit transfer requests, i.e. local SSR signals, to configure the router in a suitable mode.

One problem of the existing solution for routing global assistant signals is that the cost for building a system for routing global assistant signals in a NoC is fairly high. For example, as shown in FIG. 1, the existing system 100 for routing SSR signals in a SMART NoC requires a large number of physical SSR wires and the length of each SSR wire is fairly long.

### SUMMARY

Embodiments of the application provide a cost-efficient solution for routing global assistant signals in a NoC, e.g., routing SSR signals in a SMART NoC.

According to one aspect of the application, a device for routing global assistant signals in a NoC is provided. The device comprises:

a signal distributing element having an associated intermediate router provided in a system for routing global assistant signals which includes at least one intermediate router electrically interposed between a source router and a destination router,

wherein the signal distributing element is configured to: based on a predetermined criterion, select either local global assistant signals generated by the associated intermediate router or upstream global assistant signals received from an upstream router of the associated intermediate router in the system for routing global assistant signals as current global assistant signals to be sent to a downstream router of the associated intermediate router in the system for routing global assistant signals.

In one embodiment of the application, the NoC is a SMART NoC, the global assistant signals are SSR signals, the signal distributing element is a SSR distributing element.

According to another aspect of the application, a method for routing global assistant signals in a NoC is provided. The method comprises:

based on a predetermined criterion by a signal distributing element having an associated intermediate router provided in a system for routing global assistant signals which includes at least one intermediate router electrically interposed between a source router and a destination router,

selecting either local global assistant signals generated by the associated intermediate router or upstream global assistant signals received from an upstream router of the associated intermediate router in the system for routing global assistant signals as current global assistant signals to be sent to a downstream router of the associated intermediate router in system for routing global assistant signals.

In one embodiment of the application, the NoC is a SMART NoC, the global assistant signals are SSR signals, the signal distributing element is a SSR distributing element.

According to another aspect of the application, a system for routing global assistant signals in a NoC is provided. The system comprises:

at least one intermediate router electrically interposed between a source router and a destination router; and at least one signal distributing element respectively associated with the at least one intermediate router,

wherein each signal distributing element is configured to: based on a predetermined criterion, select either local global assistant signals generated by its associated intermediate router or upstream global assistant signals received from an upstream router of its associated intermediate router in the system as current global assistant signals to be sent to a downstream router of its associated intermediate router in the system.

In one embodiment of the application, the NoC is a SMART NoC, the global assistant signals are SSR signals, the signal distributing element is a SSR distributing element.

In the embodiments of the application, with the signal distributing element associated with each intermediate router in the signal routing system, for each intermediate router, only one group of global assistant signals, either the local global assistant signals generated by the intermediate router or the upstream global assistant signals received from the upstream router of the intermediate router are selected as current global assistant signals and routed to the downstream router of the intermediate router. Thus, only one physical wire is required between two adjacent electrically-coupled routers in the signal routing system. Compared with the existing SSR routing system in the SMART NoC, both the number and the length of the physical wires will be significantly reduced with the application.

### BRIEF DESCRIPTION OF THE DRAWINGS

The application will be described in detail with reference to the accompanying drawings, in which:

FIG. 1 is an existing system for routing SSR signals in a SMART NoC;

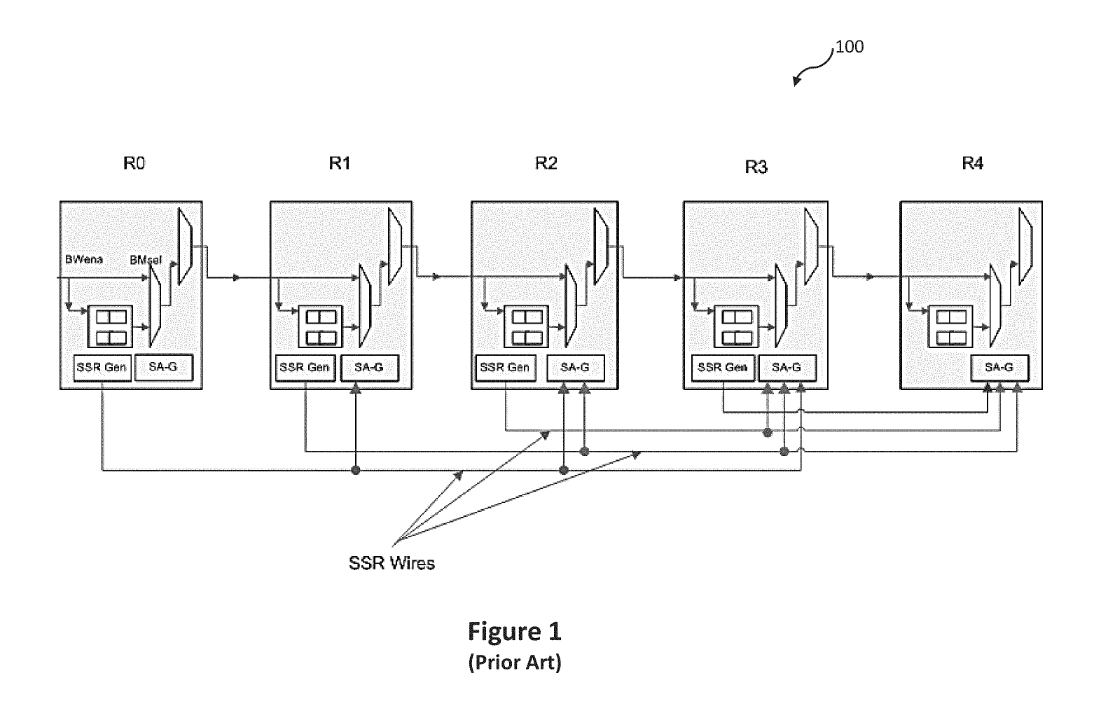

FIG. 2 is a block diagram of a system for routing global assistant signals in a NoC according to a first embodiment of the application;

FIG. 3 is a block diagram of a system for routing global assistant signals in a NoC according to a second embodiment of the application;

FIG. 4 is a block diagram of a system for routing global assistant signals in a NoC according to a third embodiment of the application;

FIG. 5 is a block diagram of a system for routing global assistant signals in a NoC according to a fourth embodiment of the application; and

FIG. 6 is a flow chart illustrating a method for routing global assistant signals in a NoC according to one embodiment of the application.

### DETAILED DESCRIPTION OF EMBODIMENTS

In the following description, numerous specific details are set forth in order to provide a thorough understanding of various illustrative embodiments of the application. It will be understood, however, to one skilled in the art, that embodiments of the application may be practiced without some or all of these specific details. It is understood that the terminology used herein is for the purpose of describing particular embodiments only, and is not intended to limit the scope of the application. In the drawings, like reference numerals refer to same or similar functionalities or features throughout the several views.

Embodiments of the application provide a solution for routing global assistant signals in a NoC, e.g. SSR signals in a SMART NoC, or other similar global assistant signals in an EXpress TRAversal with global assistant signals (EXTRA) NoC which is an optimized NoC. When a flit is traversing through EXTRA NoC, EXTRA NoC routers can bypass certain or all pipeline stages to reduce the flit traversal latency. A SMART NoC is one type of EXTRA. Global assistant signals are used to build an express routing system across multi-hops in a NoC to communicate certain information, e.g., the flit information, Virtual Channel (VC) status information, etc, to enable different working mode dynamically, e.g., bypass mode and stop mode, for more efficient flit delivery in the NoC. The express routing system across multi-hops refers to a system including at least one intermediate router disposed between a source router and a destination router.

In the solution provided by the embodiments of the application, at least one intermediate router electrically interposed between a source router and a destination router; and at least one signal distributing element respectively associated with the at least one intermediate router are provided. Each signal distributing element is configured to select either local global assistant signals generated by its associated intermediate router or upstream global assistant signals received from an upstream router of its associated intermediate router as current global assistant signals to be sent to a downstream router of its associated intermediate router based on a predetermined criterion.

The predetermined criterion may be a local priority criterion, i.e. once local global assistant signals have been generated by the intermediate router, the local global assistant signals will be selected as current global assistant signals to be sent to a downstream router of the intermediate router regardless of whether or not upstream global assistant signals have been received from an upstream router of the intermediate router; or a global priority criterion, i.e. once the upstream global assistant signals have been received by the signal distributing element associated with the intermediate router, the upstream global assistant signals will be selected as the current signals to be sent to a downstream router of the intermediate router regardless of whether or not local global assistant signals have been generated by the intermediate router.

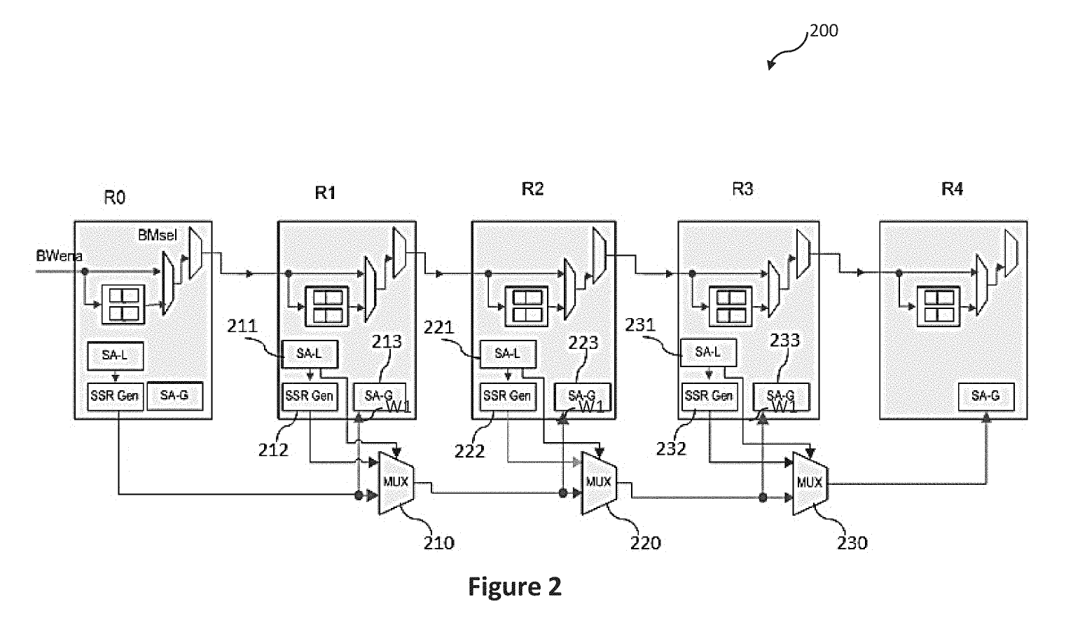

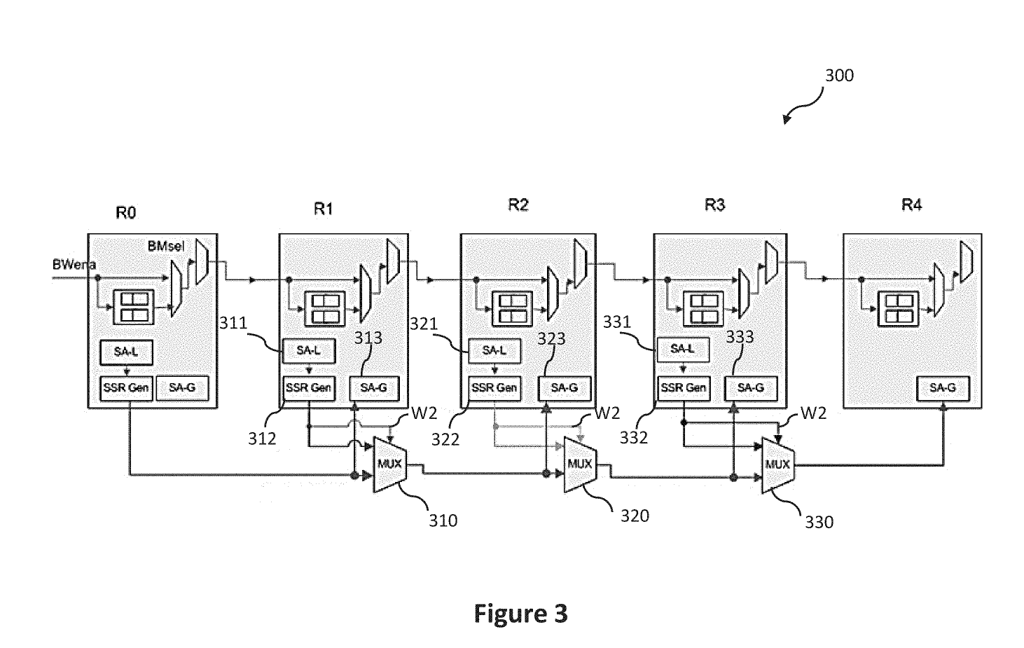

FIG. 2 and FIG. 3 show block diagrams of two systems 200, 300 for routing global assistant signals in a NoC according to a first and a second embodiment of the application. In these two embodiments, the NoC is a SMART NoC, the global assistant signals are SSR signals and the local priority criterion is adopted.

Referring to FIG. 2, in the first embodiment, the system 200 comprises three intermediate routers R1, R2, and R3 which are connected in series and electrically interposed between a source router R0 and a destination router R4, and three multiplexers 210, 220, 230 respectively associated with the three intermediate routers R1, R2 and R3. Each of the multiplexers 210, 220, 230 is disposed outside its associated intermediate router R1, R2, R3 and electrically connected to its associated intermediate router R1, R2, R3 using physical wires. It is to be appreciated by a person skilled in the art, in certain embodiments of the application, each multiplexer may be integrated with its associated intermediate router, i.e. an additional multiplexer or other SSR distributing element is disposed within the existing intermediate router.

Each intermediate router R1, R2, R3 in the system 200 is electrically coupled to its respective upstream router and downstream router. For example, the source router R0 is the upstream router of the intermediate router R1, the intermediate router R2 is a downstream router of the intermediate router R1.

Each intermediate router R1, R2, R3 includes a local switch allocation (SA-L) module 211, 221, 231, a SSR generation (SSR-gen) module 212, 222, 232 and a global switch arbitration (SA-G) module 213, 223, 233.

The intermediate router R1 and its associated multiplexer 210 are taken as an example to explain the functions of each intermediate router and each multiplexer in the system 200.

The SA-L module 211 of the intermediate router R1 is configured to select a winning local flit. In order to route SSR signals based on the local priority criterion, the SA-L module 211 is further configured to generate a control signal based on whether a winning local flit has been selected. For example, if a winning local flit has been selected, the SA-L module 211 generates a first predetermined control signal, e.g. 1 or true; if no winning local flit has been selected, the SA-L module 211 generates a second predetermined control signal, e.g. 0 or false. As shown in FIG. 2, the control signal generated by the SA-L module 211 may be sent to the multiplexer 210 through a physical wire W1.

The SSR-gen module 212 of the intermediate router R1 is configured to generate local SSR signals for a winning local flit selected by the SA-L module.

The SA-G module 213 is configured to perform global arbitration for the intermediate router. Each intermediate router R1, R2, R3 may also include other modules. The functions of SA-G module and other modules in the intermediate router are well known to a person skilled in the art, and therefore these functions will not be explained in detail here.

The multiplexer 210 is configured to select current SSR signals to be sent to the downstream router R2 based on the control signal generated by the SA-L module 211. For example, if the control signal generated by the SA-L module 211 corresponds to the first predetermined control signal, the multiplexer 210 selects the local SSR signals generated by the SSR-gen module 212 as the current signals to be sent to the downstream router R2 regardless of whether or not upstream SSR signals have been received from the upstream router R0; if the control signal generated by the SA-L module 211 corresponds to the second predetermined control signal, and the multiplexer 210 has received upstream SSR signals from the upstream router R0, the multiplexer 210 selects the upstream SSR signals as current signals to be sent to the downstream router R2.

FIG. 3 shows the block diagram of a system 300 for routing global assistant signals in a NoC according to a second embodiment of the application. The intermediate router R1 and its associated multiplexer 310 are taken as an example to explain the functions of each intermediate router and each multiplexer in the system 300.

The SA-L module 311 of the intermediate router R1 is configured to select a winning local flit.

The SSR-gen module 312 of the intermediate router R1 is configured to generate local SSR signals for a winning local flit selected by the SA-L module 311. In order to route SSR signals based on the local priority criterion, the SSR-gen module 312 is further configured to set value of a valid bit associated with local SSR signals. For example, if a winning local flit has been selected by the SA-L module 311, the SSR-gen module 312 sets value of the valid bit as a first predetermined value, e.g. 1; if no winning local flit has been selected by the SA-L module 311, the SSR-gen module 312 sets value of the valid bit as a second predetermined value, e.g. 0. As shown in FIG. 3, the valid bit associated with local SSR signals set by the SSR-gen module 312 may be sent to the multiplexer 310 through a physical wire W2.

The multiplexer 310 is configured to select current SSR signals to be sent to the downstream router R2 based on the value of the valid bit associated with local SSR signals set by the SSR-gen module 312. For example, if the value of the valid bit set by the SSR-gen module 312 corresponds to the first predetermined value, the multiplexer 310 selects the local SSR signals generated by the SSR-gen module 312 as the current signals to be sent to the downstream router R2 regardless of whether or not upstream SSR signals have been received from the upstream router R0; if the value of the valid bit set by the SSR-gen module 312 corresponds to the second predetermined value, and the multiplexer 310 has received upstream SSR signals from the upstream router R0, the multiplexer 310 selects the upstream SSR signals as current signals to be sent to the downstream router R2.

In the above two embodiments, each multiplexer in the system selects current signals to be sent to a downstream router based on a control signal or valid bit associated with local SSR signals generated by the associated intermediate router.

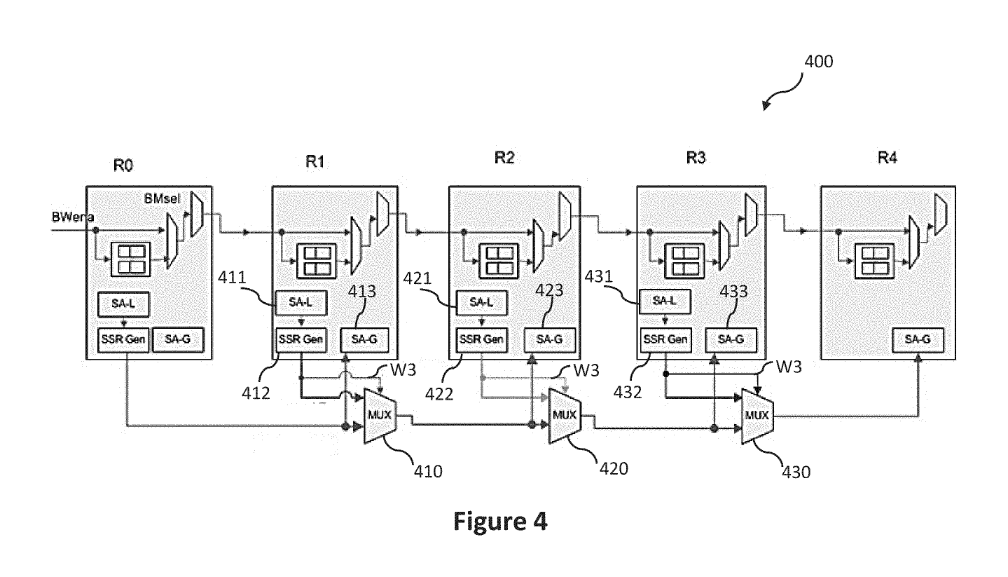

FIG. 4 shows a block diagram of a system 400 for routing global assistant signals in a NoC according to a third embodiment of the application. In this embodiment, the NoC is a SMART NoC, the global assistant signals are SSR signals and the global priority criterion is adopted. Each multiplexer in the system selects current signals to be sent to a downstream router based on valid bit indicating whether upstream SSR signals have been received.

Referring to FIG. 4, the intermediate router R1 and its associated multiplexer 410 are taken as an example to explain the functions of each intermediate router and each multiplexer in the system 400.

The SA-L module 411 of the intermediate router R1 is configured to select a winning local flit.

The SSR-gen module 412 of the intermediate router R1 is configured to generate local SSR signals for a winning local flit selected by the SA-L module 411.

The multiplexer 410 is configured to select current SSR signals to be sent to the downstream router R2 based on value of a valid bit indicating whether upstream SSR signals have been received. For example, if the value of the valid bit indicating whether upstream SSR signals have been received corresponds to a first predetermined value, e.g. 1, the multiplexer 410 selects the upstream SSR signals received from the upstream router R0 as the current signals to be sent to the downstream router R2 regardless of whether or not local SSR signals have been generated by the SSR-gen module 412; if the value of the valid bit indicating whether upstream SSR signals have been received corresponds to a second predetermined value, e.g. 0, the multiplexer 410 selects the local SSR signals generated by the SSR-gen module 412 as current signals to be sent to the downstream router R2. As shown in FIG. 4, the valid bit indicating whether upstream SSR signals have been received may be sent to the multiplexer 410 through a physical wire W3.

In the three embodiments described above, the multiplexer is used as a SSR distributing element to route the local SSR signals generated by the intermediate router or upstream SSR signals received from upstream router of the intermediate router associated with the multiplexer. A control signal/valid bit generated/set by the intermediate router, or received from the upstream router is used to control the multiplexer to select the current signals. In other embodiments of the application, a router or distributor with logical functions may be used as a SSR distributing element.

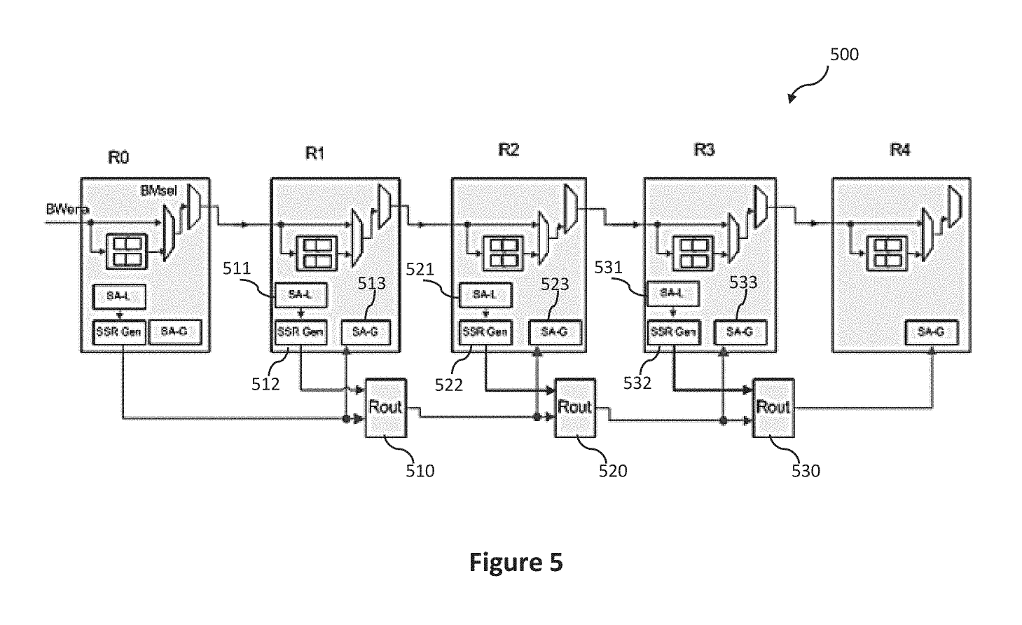

FIG. 5 shows a block diagram of a system 500 for routing global assistant signals in a NoC according to a fourth embodiment of the application. In this embodiment, the NoC is a SMART NoC, the global assistant signals are SSR signals and routers 510, 520, 530 are used as SSR distributing elements.

The intermediate router R1 and its associated router 510 are taken as an example to explain the functions of each intermediate router and each router in the system 500.

The SA-L module 511 of the intermediate router R1 is configured to select a winning local flit.

The SSR-gen module 512 of the intermediate router R1 is configured to generate local SSR signals for a winning local flit selected by the SA-L module 511, and set value of a valid bit associated with local SSR signals based on whether a winning local flit has been selected by the SA-L module 511. For example, if a winning local flit has been selected by the SA-L module 511, the SSR-gen module 512 sets value of the valid bit as a first predetermined value, e.g. 1; if no winning local flit has been selected by the SA-L module 511, the SSR-gen module 512 sets value of the valid bit as a second predetermined value, e.g. 0.

The router 510 is configured to select current SSR signals to be sent to the downstream router R2 based on the value of the valid bit associated with local SSR signals which was set by the SSR-gen module 512 and value of a valid bit indicating whether upstream SSR signals have been received.

If the local priority criterion is adopted, the router 510 may be configured to select the local SSR signals generated by the SSR-gen module 512 as the current signals to be sent to the intermediate router R2 if the value of the valid bit associated with local SSR signals corresponds to the first predetermined value ; or select the upstream SSR signals received from the upstream router R0 as the current signals to be sent to the downstream router R2 if the value of the valid bit associated with local SSR signals corresponds to the second predetermined value, and the value of the valid bit indicating whether upstream SSR signals have been received corresponds to a first predetermined value, e.g. 1.

If the global priority criterion is adopted, the router 510 may be configured to select the upstream SSR signals received from the upstream router R0 as the current signals to be sent to the downstream router R2 if the value of the valid bit indicating whether upstream SSR signals have been received corresponds to a first predetermined value, e.g. 1, or select the local SSR signals generated by the SSR-gen module 512 as the current signals to be sent to the intermediate router R2 if the value of the valid bit indicating whether upstream SSR signals have been received corresponds to a second predetermined value, e.g. 0 and the value of the valid bit associated with local SSR signals corresponds to the first predetermined value, e.g. 1.

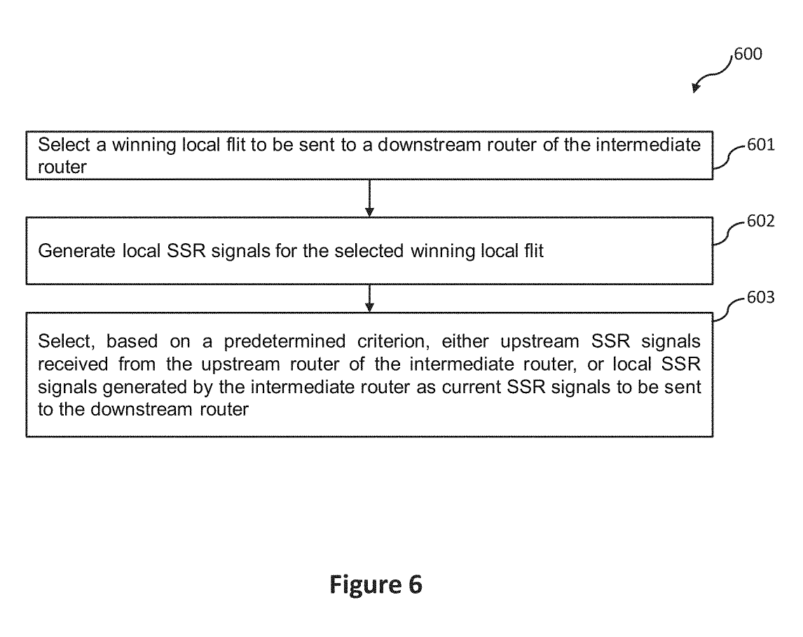

FIG. 6 is a flow chart illustrating a method 600 for routing global assistant signals in a NoC according to one embodiment of the application. In this embodiment, the NoC is a SMART NoC, the global assistant signals are SSR signals. One of the intermediate routers in the system for routing global assistant signals in the NoC is taken as an example to explain the process for routing SSR signals in each intermediate router in the system for routing global assistant signals. The system for routing global assistant signals in the NoC comprises at least one intermediate router connected in series and electrically interposed between a source router and a destination router and at least one SSR distributing element respectively associated with the at least one intermediate router.

In block 601, the intermediate router selects a winning local flit.

In block 602, the intermediate router generates local SSR signals for the selected winning local flit.

In block 603, based on a predetermined criterion, the SSR distributing element associated with the intermediate router selects either upstream SSR signals received from an upstream router of the intermediate router, or local SSR signals generated by the intermediate router as current SSR signals to be sent to the downstream router of the intermediate router.

When the local priority criterion is adopted, in one embodiment of the application, the method further comprises:

the intermediate router generates a control signal based on whether a winning local flit has been selected; and the SSR distributing element associated with the intermediate router, based on the generated control signal, selects either local SSR signals generated by the associated intermediate router or upstream SSR signals received from an upstream router of the associated intermediate router as current SSR signals to be sent to the downstream router.

In one example of the embodiment, the intermediate router generates a first predetermined control signal, e.g. 1 or true, if a winning local flit has been selected, or generates a second predetermined control signal if no winning local flit has been selected. Accordingly, the SSR distributing element associated with the intermediate router selects the generated local SSR signals as the current signals to be sent to the downstream router if the first predetermined control signal was generated regardless of whether or not upstream SSR signals have been received.

When the local priority criterion is adopted, in another embodiment of the application, the method further comprises:

the intermediate router sets value of a valid bit associated with local SSR signals based on whether a winning local flit has been selected, and the SSR distributing element associated with the intermediate router, based on the value of the valid bit set by the intermediate router, selects either local SSR signals generated by the associated intermediate router or upstream SSR signals received from an upstream router of the associated intermediate router as current SSR signals to be sent to the downstream router.

In one example of the embodiment, the intermediate router sets the value of the valid bit associated with local SSR signals as a first predetermined value, e.g. 1, if a winning local flit has been selected, or sets the value of the valid bit associated with local SSR signals as a second predetermined value, e.g. 0, if no winning local flit has been selected. Accordingly, the SSR distributing element associated with the intermediate router selects the generated local SSR signals as the current signals to be sent to the downstream router if the value of the valid bit associated with local SSR signals was set as the first predetermined value regardless of whether or not upstream SSR signals have been received.

When the local priority criterion is adopted, in another embodiment of the application, the method further comprises:

the intermediate router sets value of a valid bit associated with local SSR signals based on whether a winning local flit has been selected, and the SSR distributing element associated with the intermediate router, based on the value of the valid bit associated with local SSR signals set by the intermediate router and value of a valid bit indicating whether upstream SSR signals have been received, selects either local SSR signals generated by the associated intermediate router or upstream SSR signals received from an upstream router of the associated intermediate router as current SSR signals to be sent to the downstream router. The value of a valid bit indicating whether upstream SSR signals have been received may be set by the upstream router of the intermediate router.

In one example of the embodiment, the intermediate router sets the value of the valid bit associated with local SSR signals as a first predetermined value, e.g. 1, if a winning local flit has been selected, or sets the value of the valid bit associated with local SSR signals as a second predetermined value, e.g. 0, if no winning local flit has been selected. Accordingly, the SSR distributing element associated with the intermediate router selects the generated local SSR signals as the current signals to be sent to the downstream router if the value of the valid bit associated with local SSR signals was set as the first predetermined value, or selects upstream SSR signals received from the upstream router as current signals to be sent to the downstream router if the value of the valid bit associated with local SSR signals was set as the second predetermined value, and value of a valid bit indicating whether upstream SSR signals have been received was set as a predetermined value, e.g. 1.

When the global priority criterion is adopted, in one embodiment of the application, the method further comprises:

the SSR distributing element selects upstream SSR signals received from the upstream router as the current SSR signals if the SSR distributing element determines that the upstream SSR signals have been received regardless of whether or not local signals have been generated by the intermediate router.

In one example of this embodiment, the SSR distributing element may determine that the upstream SSR signals have been received if value of a valid bit associated with the upstream SSR signals corresponds to a predetermined value, e.g. 1. The value of the valid bit indicating whether upstream SSR signals have been received may be set by the upstream router of the intermediate router.

When the global priority criterion is adopted, in another embodiment of the application, the method further comprises:

the SSR distributing element selects current SSR signals to be sent to the downstream router based on value of a valid bit indicating whether upstream SSR signals have been received, and value of a valid bit associated with local SSR signals generated by the intermediate router based on whether a winning local flit has been selected.

In one example of the embodiment, the SSR distributing element selects the upstream SSR signals received from the upstream router as the current signals to be sent to the downstream router if the value of the valid bit indicating whether upstream SSR signals have been received corresponds to a first predetermined value, e.g. 1, or select the local SSR signals generated by the intermediate router as the current signals to be sent to the downstream router if the value of the valid bit indicating whether upstream SSR signals have been received corresponds to a second predetermined value, e.g. 0 and the value of the valid bit associated with local SSR signals corresponds to the first predetermined value, e.g. 1.

As will be appreciated from the above, embodiments of the application provide a cost-efficient solution for routing SSR signals. With the SSR distributing element associated with each intermediate router in the system for routing SSR signals, each intermediate router will only route one group of SSR signals, either the local SSR signals generated by the intermediate router or the upstream SSR signals from the upstream router of the intermediate router. Thus, only one physical SSR wire is required between two adjacent intermediate routers in the system for routing SSR signals. Compared with existing SSR routing method, both the number and the length of the physical SSR wires will be significantly reduced with the application.

It is to be understood that the embodiments and features described above should be considered exemplary and not restrictive. For example, the above-described embodiments may be used in combination with each other. Many other embodiments will be apparent to those skilled in the art from consideration of the specification and practice of the application. Although embodiments of the application are illustrated relative to routing of SSR signals in a SMART NoC, it is to be appreciated by a person skilled in the art that the teachings may be equally applicable to routing of other similar global assistant signals in a non-SMART NoC. The scope of the application should, therefore, be determined with reference to the appended claims, along with the full scope of equivalents to which such claims are entitled. Furthermore, certain terminology has been used for the purposes of descriptive clarity, and not to limit the disclosed embodiments of the application.

What is claimed is:

1. A device for routing global assistant signals in a Network-on-chip (NoC), the device comprising:
a signal distributing element having an associated intermediate router provided in a system for routing global assistant signals in the NoC which includes at least one intermediate router electrically interposed between a source router and a destination router,
wherein the signal distributing element is configured to: based on a predetermined criterion, select either local global assistant signals generated by the associated intermediate router or upstream global assistant signals received from an upstream router of the associated intermediate router a system for routing global assistant signals in the NoC as current global assistant signals to be sent to a downstream router of the associated intermediate router a system for routing global assistant signals in the NoC.

2. The device according to claim 1, wherein the signal distributing element is integrated with the intermediate router.

3. The device according to claim 1, wherein the NoC is a SMART NoC, the global assistant signals are SMART-hop Setup Request (SSR) signals, and the signal distributing element is a SSR distributing element.

4. The device according to claim 3, wherein the intermediate router comprises:
a local switch allocation (SA-L) module configured to select a winning local flit and
a SSR generation (SSR-gen) module configured to generate local SSR signals for the winning local flit selected by the SA-L module.

5. The device according to claim 4, wherein the SA-L module is further configured to generate a control signal based on whether a winning local flit has been selected by the SA-L module,
wherein the SSR distributing element is further configured to select either local SSR signals generated by the associated intermediate router or upstream SSR signals received from an upstream router of the associated intermediate router as current SSR signals to be sent to the downstream router based on the control signal generated by the SA-L module.

6. The device according to claim 5, wherein the SA-L module is further configured to generate a first predetermined control signal if a winning local flit has been selected, or generate a second predetermined control signal if no winning local flit has been selected;
wherein the SSR distributing element is further configured to select the local SSR signals generated by the SSR-gen module as the current SSR signals if the first predetermined control signal has been generated by the SA-L module regardless of whether or not upstream SSR signals have been received; or select the received upstream SSR signals as the current SSR signals if the second predetermined control signal has been generated by the SA-L module.

7. The device according to claim 4, wherein the SSR-gen module is further configured to set a value of a valid bit associated with local SSR signals based on whether a winning local flit has been selected by the SA-L module; and
the SSR distributing element is further configured to select either local SSR signals generated by the associated intermediate router or upstream SSR signals received from an upstream router of the associated intermediate router as current SSR signals to be sent to the downstream router based on the value of the valid bit set by the SSR-gen module.

8. The device according to claim 7, wherein the SSR distributing element is further configured to select either local SSR signals generated by the associated intermediate router or upstream SSR signals received from an upstream router of the associated intermediate router as current SSR signals to be sent to the downstream router based on value of a valid bit indicating whether upstream SSR signals have been received.

9. The device according to claim 7, wherein the SSR-gen module is further configured to set the value of the valid bit associated with local SSR signals as a first predetermined value if a winning local flit has been selected by the SA-L module, or set the value of the valid bit associated with local SSR signals as a second predetermined value if no winning local flit has been selected by the SA-L module, and
the SSR distributing element is further configured to select the local SSR signals generated by the SSR-gen module as the current SSR signals if the value of the valid bit associated with local SSR signals was set as a first predetermined value regardless of whether or not upstream SSR signals have been received; or select the received upstream SSR signals as the current SSR signals if the value of the valid bit associated with local SSR signals was set as the second predetermined value by the SA-L module.

10. The device according to claim 9, the SSR distributing element is further configured to select upstream SSR signals received from an upstream router of the associated intermediate router as current SSR signals to be sent to the downstream router if the value of the valid bit associated with local SSR signals was set as the second predetermined value, and the value of the valid bit indicating whether upstream SSR signals have been received was set as a predetermined value.

11. The device according to claim 1, wherein the signal distributing element is further configured to select upstream global assistant signals received from the upstream router as the current SSR signals if the signal distributing element determines that the upstream SSR signals have been received regardless of whether or not local global assistant signals have been generated by the intermediate router.

12. The device according to claim 11, wherein the signal distributing element is further configured to select the upstream global assistant signals received from the upstream router as the current SSR signals if a value of a valid bit indicating whether the upstream global assistant signals have been received was set as a predetermined value.

13. The device according to claim 1, wherein the signal distributing element includes a multiplexer or a router.

14. A method for routing global assistant signals in a Network-on-chip (NoC), the method comprising:
based on a predetermined criterion, by a signal distributing element having an associated intermediate router provided in a system for routing global assistant signals in the NoC which includes at least one intermediate router electrically interposed between a source router and a destination router,
selecting either local global assistant signals generated by the associated intermediate router or upstream global assistant signals received from an upstream router of the associated intermediate router in the system for routing global assistant signals in the NoC as current global assistant signals to be sent to a downstream router of the associated intermediate router in the system for routing global assistant signals in the NoC.

15. The method according to claim 14, wherein the NoC is a SMART NoC, the global assistant signals are SMART-hop Setup Request (SSR) signals, and the signal distributing element is a SSR distributing element.

16. The method according to claim 15, further comprising:
selecting, by the intermediate router, a winning local flit, and
generating, by the intermediate router, local SSR signals for a selected winning local flit.

17. The method according to claim 16, further comprising:
generating, by the intermediate router, a control signal based on whether a winning local flit was selected,
wherein the step of based on a predetermined criterion, selecting either local SSR signals or upstream SSR signals as current SSR signals comprises:
based on the generated control signal, selecting either local SSR signals generated by the associated intermediate router or upstream SSR signals received from an upstream router of the associated intermediate router as current SSR signals to be sent to the downstream router.

18. The method according to claim 17, wherein the step of generating a control signal further comprises:
generating a first predetermined control signal if a winning local flit has been selected, or generating a second predetermined control signal if no winning local flit has been selected,
wherein the step of selecting either local SSR signals or upstream SSR signals as current SSR signals further comprises:
selecting the generated local SSR signals as the current signals to be sent to the downstream router if the first predetermined control signal was generated regardless of whether or not upstream SSR signals have been received.

19. The method according to claim 16, further comprising:
setting, by the intermediate router, a value of a valid bit associated with local SSR signals based on whether a winning local flit was selected by the SA-L module,
wherein the step of based on a predetermined criterion, selecting either local SSR signals or upstream SSR signals as current SSR signals comprises:
based on the value of the valid bit set by the intermediate router, selecting either local SSR signals generated by the associated intermediate router or upstream SSR signals received from an upstream router of the associated intermediate router as current SSR signals to be sent to the downstream router.

20. A system for routing global assistant signals in a Network-on-chip (NoC), the system comprising:
at least one intermediate router electrically interposed between a source router and a destination router; and at least one signal distributing element respectively associated with the at least one intermediate router,
wherein each signal distributing element is configured to: based on a predetermined criterion, select either local global assistant signals generated by its associated intermediate router or upstream global assistant signals received from an upstream router of its associated intermediate router in the system as current SSR signals to be sent to a downstream router of its associated intermediate router in the system.
